(19) United States
(12) Patent Application Publication
(10) Pub. No.: US 2026/0153153 A1
(43) Pub. Date: Jun. 4, 2026

(54) ROTARY VALVE AND METHOD FOR FORMING REINFORCED RESIN MEMBER OF ROTARY VALVE

(71) Applicant: SHIMADZU CORPORATION, Kyoto (JP)

(72) Inventors: Ryota KANAMARU, Kyoto (JP); Kenichi YASUNAGA, Kyoto (JP); Sachiko MATSUDA, Kyoto (JP); Hiromu YAMASAKI, Kyoto (JP)

(73) Assignee: SHIMADZU CORPORATION, Kyoto (JP)

(21) Appl. No.: 19/374,561

(22) Filed: Oct. 30, 2025

(30) Foreign Application Priority Data
Dec. 2, 2024 (JP) 2024-209487
Jul. 29, 2025 (JP) 2025-126261

(51) Int. Cl. F16K 3/02; F16K 3/08

(52) U.S. Cl. CPC F16K 3/0263; F16K 3/08

(57) ABSTRACT

A rotary valve comprises a stator (4), a rotor shaft (8) that rotates on its axis, and a rotor (6) that is held at a tip of the rotor shaft (8) and rotates together with the rotor shaft (8) while in surface contact with the stator (4). The stator (4) and the rotor (6) have sliding surfaces that slide against each other due to the rotation of the rotor (6). One of the stator (4) and the rotor (6) is a reinforced resin member composed of a fiber-reinforced resin containing reinforcing fibers for improving hardness. The reinforcing fibers exposed on the sliding surface of the reinforced resin member are mainly oriented along a direction perpendicular to the sliding surface of the reinforced resin member.

### TECHNICAL FIELD

The present invention relates to a rotary valve used in an analytical instrument such as a liquid chromatograph, and a method for forming a reinforced resin member of the rotary valve.

### BACKGROUND ART

A rotary flow path switching valve (hereinafter referred to as a rotary valve) used in a liquid chromatograph needs to withstand high liquid-feeding pressure from several tens of MPa to several hundreds of MPa. Therefore, an elastic member such as a coil spring is used to press a rotor against a stator with a strong force to ensure sealing performance between the rotor and the stator (see Patent Literature 1).

Since the rotor and the stator slide against each other while being pressed with a strong force, high sealing performance and wear resistance are required for the sliding surfaces of the rotor and the stator. Therefore, a hard material such as ceramic or stainless steel coated with DLC (diamond-like carbon) is generally used as the material for the stator (see, for example, Patent Literature 2), and a soft material such as PEEK (polyetheretherketone) or polyimide is generally used as the material for the rotor.

### PRIOR ART DOCUMENTS

### Patent Literature

[Patent Literature 1] Japanese Patent No. 6773233

[Patent Literature 2] U.S. Pat. No. 8,438,910

### SUMMARY OF THE INVENTION

### Problem to be Solved by the Invention

An environment where a pressure of 130 MPa or more is applied to a rotor or a stator is a harsh environment in which a soft material such as PEEK undergoes plastic deformation. When a soft material is slid against a hard material in such an environment, the soft material wears quickly, shortening the lifespan of the component. Therefore, countermeasures have been taken, such as using a fiber-reinforced resin containing reinforcing fibers, such as carbon fibers, as the soft material. However, even with such wear countermeasures, there has been a problem in that the sliding surface of one or both of the rotor and the stator wears, and the sealing performance between the rotor and the stator deteriorates after a certain period of use, causing liquid leakage.

The present invention has been made in view of the above problem, and an object thereof is to enable the sealing performance between a rotor and a stator to be maintained over a long period.

### Means for Solving the Problem

It has been found that when one of a stator and a rotor that slide against each other is formed of a hard material and the other member is formed of a fiber-reinforced resin, the member formed of the hard material is worn by the reinforcing fibers contained in the fiber-reinforced resin, which promotes a decrease in the sealing performance between the stator and the rotor. The inventors of the present invention have found that the orientation direction of the reinforcing fibers contained in the fiber-reinforced resin on the sliding surface affects the wear of the member formed of the hard material, and that by making the orientation direction of the reinforcing fibers exposed on the sliding surface closer to a direction perpendicular to the sliding surface, the wear of the member formed of the hard material can be suppressed.

A first rotary valve according to the present invention based on the above findings comprises a stator, a rotor shaft that rotates on its axis, and a rotor that is held at a tip of the rotor shaft and rotates together with the rotor shaft while in surface contact with the stator, wherein the stator and the rotor have sliding surfaces that slide against each other due to the rotation of the rotor, one of the stator and the rotor is a reinforced resin member composed of a fiber-reinforced resin containing reinforcing fibers for improving hardness, and the reinforcing fibers exposed on the sliding surface of the reinforced resin member are mainly oriented along a direction perpendicular to the sliding surface of the reinforced resin member.

Further, when the stator is formed of a hard material and the rotor is formed of a soft material, the rotor tends to wear, and the periphery of the grooves of the rotor wears, causing the grooves to widen and making liquid leakage more likely to occur.

A second rotary valve according to the present invention, which addresses the above problem, comprises a stator, a rotor shaft that rotates on its axis, and a rotor that is held at a tip of the rotor shaft and rotates together with the rotor shaft while in surface contact with the stator, wherein the stator is composed of a resin, and at least a sliding surface of the rotor that contacts the stator is composed of a material harder than the stator.

Further, if the opposing surfaces of the stator and the rotor are not parallel to each other, problems such as uneven contact between the stator and the rotor, which prevents the designed pressure resistance performance from being obtained, or accelerated wear due to sliding with uneven contact, leading to a decrease in durability, occur. To prevent such problems, it is necessary to form the stator, the rotor, and the members supporting them with high precision, or to provide a separate member that elastically supports the rotor to allow for inclination of the rotor, which is costly.

A third rotary valve according to the present invention, which addresses the above problem, comprises a stator, a rotor shaft that rotates on its axis, and a rotor that is held at a tip of the rotor shaft and rotates together with the rotor shaft while in surface contact with the stator, wherein a substantially spherical portion, which is a part of either the rotor or the rotor shaft, is provided between the rotor and the rotor shaft, and the rotor and the rotor shaft are in direct contact at the substantially spherical portion, whereby the sliding surface of the rotor is capable of tilting from a state perpendicular to the rotation axis of the rotor shaft.

Furthermore, when a DLC coating is applied to one of the rotor and the stator (e.g., the stator) to improve the sliding properties and wear resistance of the rotor and the stator, the DLC film may peel off from the substrate, causing liquid leakage between the rotor and the stator. In particular, it has been found that such a problem occurs remarkably when one of the rotor and the stator is a DLC-formed member on which a DLC film is formed, and the other is a soft member such as a resin. This is considered to be because the soft member is pressed against the DLC-formed member with a strong force, causing the deformed soft member to enter the opening at the end of the flow path of the DLC-formed member, and when they slide, the soft member that has entered the opening exerts a force that scrapes off the DLC film at the edge of the opening. Therefore, the inventors of the present invention focused on the thickness from the surface of the substrate to the surface of the DLC film on the sliding surface of the DLC-formed member. In DLC coating, it is known that the thicker the DLC film formed, the higher the wear resistance, and the thickness of the DLC film formed by DLC coating is generally about 1 to 3μm. However, if the DLC film is made thicker, the residual stress also increases, making the DLC film more likely to peel off from the substrate. Furthermore, if the thickness from the surface of the substrate to the surface of the DLC film is large, when the DLC-formed member and the soft member slide, the DLC film at the edge of the opening of the DLC-formed member is more likely to receive stress in the peeling direction from the soft member that has entered the opening.

As a result of conducting sliding experiments with a soft member using a plurality of DLC-formed members with different thicknesses from the surface of the substrate to the surface of the DLC film, the inventors of the present invention confirmed that peeling of the DLC film is less likely to occur and the lifespan is longer in a DLC-formed member with a smaller thickness from the surface of the substrate to the surface of the DLC film compared to a DLC-formed member with a larger thickness, and that this is particularly remarkable when the thickness from the surface of the substrate to the surface of the DLC film is 0.5 μm or less. A fourth rotary valve according to the present invention is based on such findings.

That is, a fourth rotary valve according to the present invention comprises a stator and a rotor that rotates while in surface contact with the stator, wherein each of the stator and the rotor has a sliding surface that slides against the other due to the rotation of the rotor, one of the stator and the rotor is a DLC-formed member whose sliding surface is formed of a DLC film, and a thickness from a surface of a substrate to a surface of the DLC film on the sliding surface side of the DLC-formed member is 0.5 μm or less.

A method according to the present invention is a method for forming, as a reinforced resin member composed of a fiber-reinforced resin containing reinforcing fibers for improving hardness, one of a rotor and a stator having sliding surfaces that directly contact and slide against each other in the first rotary valve described above, the method comprising:
a flowing step of causing a liquid fiber-reinforced resin to flow in one direction that is a direction perpendicular to a surface that will become the sliding surface when formed as the reinforced resin member;
a curing step of curing the fiber-reinforced resin after the flowing step; and
a forming step of forming, after the curing step, the reinforced resin member in which the reinforcing fibers exposed on the sliding surface are mainly oriented along the direction perpendicular to the sliding surface, using the cured fiber-reinforced resin as a substrate.

### Effects of the Invention

According to the first rotary valve of the present invention, since one of the stator and the rotor is a reinforced resin member composed of a fiber-reinforced resin containing reinforcing fibers for improving hardness, and the reinforcing fibers exposed on the sliding surface of the reinforced resin member are mainly oriented along a direction perpendicular to the sliding surface of the reinforced resin member, wear of the sliding surfaces of the stator and the rotor is reduced, and the sealing performance between the stator and the rotor can be maintained over a long period.

According to the second rotary valve of the present invention, since the stator is composed of a resin, and at least the sliding surface of the rotor that contacts the stator is composed of a material harder than the stator, the widening of grooves in the rotor due to wear is suppressed, and the sealing performance between the stator and the rotor can be maintained over a long period.

According to the third rotary valve of the present invention, since a substantially spherical portion, which is a part of either the rotor or the rotor shaft, is provided between the rotor and the rotor shaft, and the rotor and the rotor shaft are in direct contact at the substantially spherical portion, whereby the sliding surface of the rotor is capable of tilting from a state perpendicular to the rotation axis of the rotor shaft, uneven contact between the stator and the rotor can be prevented, and the sealing performance between the stator and the rotor can be maintained over a long period.

According to the fourth rotary valve of the present invention, since one of the stator and the rotor is a DLC-formed member whose sliding surface is formed of a DLC film, and the thickness from the surface of the substrate to the surface of the DLC film on the sliding surface side of the DLC-formed member is 0.5 μm or less, peeling of the DLC film of the DLC-formed member is less likely to occur, and the lifespan of the DLC-formed member can be extended.

According to the method of the present invention, it is possible to form a reinforced resin member in which the reinforcing fibers exposed on the sliding surface are mainly oriented along a direction perpendicular to the sliding surface.

### BRIEF DESCRIPTION OF THE DRAWINGS

FIG. 1 is a cross-sectional view showing an embodiment of a rotary valve.

FIG. 2 is a conceptual diagram for explaining an example of a method for forming a fiber-reinforced resin.

FIG. 3 is a diagram showing the orientation direction of reinforcing fibers when a reinforced resin member is formed by causing a fiber-reinforced resin to flow in a direction parallel to a direction that will become a sliding surface.

FIG. 4 is an image showing the state of the respective sliding surfaces of a stator and a rotor after using, as the stator, a reinforced resin member in which reinforcing fibers exposed on the sliding surface are mainly oriented along a direction perpendicular to the sliding surface.

FIG. 5 is an image showing the state of the respective sliding surfaces of a stator and a rotor after using, as the stator, a reinforced resin member in which reinforcing fibers exposed on the sliding surface are mainly oriented along the sliding surface.

FIG. 6 is a diagram showing the structure of a contact portion between the rotor and a rotor shaft.

FIG. 7 is a diagram showing an example of a cross-sectional structure of a DLC-formed member.

### MODE FOR CARRYING OUT THE INVENTION

Hereinafter, an embodiment of a rotary valve according to the present invention will be described with reference to the drawings.

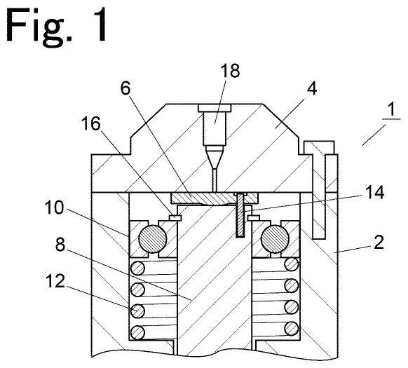

As shown in FIG. 1, a rotary valve 1 includes a housing 2, a stator 4, a rotor 6, a rotor shaft 8, a bearing 10, and an elastic member 12.

The housing 2 is an integral member having a substantially hollow cylindrical shape with an open tip (upper end in the figure). The stator 4 is fixed to the tip of the housing 2 by bolts. The stator 4 is provided with a plurality of pipe connection parts 18 for connecting pipes. Note that only one pipe connection part 18 is shown in the figure. The pipe connection part 18 communicates with the inner space side surface (lower surface in the figure) of the housing 2 via a flow path. The rotor 6 rotates in a state where it is in contact with the lower surface of the stator 4, whereby the connection state between a plurality of pipes connected to the stator 4 is switched.

The rotor shaft 8 is disposed in the inner space of the housing 2 with its tip (upper end in the figure) facing the stator 4 side. The rotor shaft 8 is rotated on its axis by a motor (not shown). The rotor 6 is held at the tip of the rotor shaft 8 and rotates with the rotation of the rotor shaft 8.

The bearing 10 is interposed between the outer peripheral surface of the rotor shaft 8 and the inner peripheral surface of the housing 2, and supports the rotor shaft 8 to stabilize its rotation. In this embodiment, a retaining ring 16 is attached to the tip of the rotor shaft 8, and the bearing 10 engages with the retaining ring 16.

The elastic member 12 is disposed in a compressed state on the base end side of the rotor shaft 8 relative to the bearing 10 in the inner space of the housing 2, so as to bias the bearing 10 toward the stator 4 side. As the bearing 10 is biased toward the stator 4 side by the elastic member 12, the rotor shaft 8 is biased toward the stator 4 side, and the rotor 6 held at the tip of the rotor shaft 8 is pressed against the stator 4. This ensures the sealing performance between the stator 4 and the rotor 6. In this embodiment, the rotor 6 is in direct contact with the stator 4, but the present invention is not limited to this, and another member fixed to the stator 4 side may be interposed between the stator 4 and the rotor 6.

The stator 4 can be composed of a resin. If the stator 4 is composed of a resin, it can be applied to uses where a solvent that is corrosive to metal is used. The resin constituting the stator 4 can be a fiber-reinforced resin such as a polyetheretherketone resin or a polyimide resin containing reinforcing fibers (e.g., carbon fibers) for improving hardness. By making the stator 4 a reinforced resin member composed of a fiber-reinforced resin, the hardness of the stator 4 can be improved, and the pressure resistance performance of the rotary valve 1 can be enhanced.

When the stator 4 is a resin, the rotor 6 can be a hard member in which at least the sliding surface (upper surface in the figure) that contacts the stator 4 is composed of a material harder than the stator 4 (e.g., ceramic, diamond-like carbon). By composing at least the sliding surface of the rotor 6 that contacts the stator 4 with a material harder than the stator 4, the widening of grooves provided in the rotor 6 due to wear is suppressed.

The present invention is not limited to this, and the rotor 6 may be formed of a fiber-reinforced resin, and at least the sliding surface of the stator 4 that contacts the rotor 6 may be composed of a material harder than the rotor 6.

When the stator 4 is a reinforced resin member composed of a fiber-reinforced resin, the reinforcing fibers of the stator 4 exposed on the sliding surface that contacts the rotor 6 are mainly oriented along a direction perpendicular to the sliding surface (lower surface in the figure) (vertical direction in the figure). When the rotor 6 is a reinforced resin member, the reinforcing fibers of the rotor 6 exposed on the sliding surface that contacts the stator 4 are mainly oriented along a direction perpendicular to the sliding surface (upper surface in the figure) that contacts the stator 4.

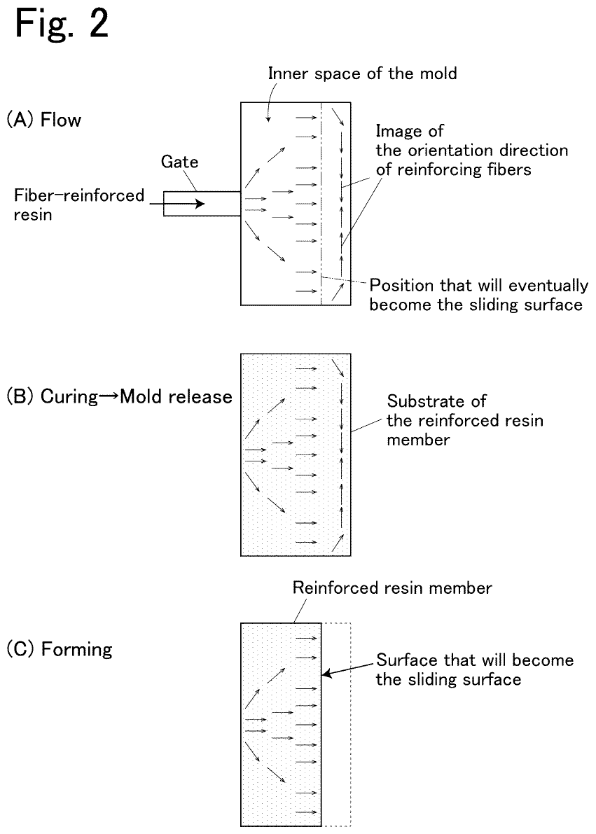

Here, a method for forming the reinforced resin member of this embodiment will be described with reference to FIG. 2. Here, a forming method by injection molding will be described as an example.

As shown in FIG. 2(A), a liquid fiber-reinforced resin is poured into the inner space of a mold while causing it to flow in a direction perpendicular to the surface that will become the sliding surface when formed as a resin-reinforced member. When the fiber-reinforced resin flows in this manner, although the reinforcing fibers are mainly oriented along the inner surface of the mold at the deepest part of the inner space of the mold, in the region closer to the gate than that, the reinforcing fibers are mainly oriented along the direction perpendicular to the surface that will become the sliding surface. Next, as shown in FIG. 2(B), after the fiber-reinforced resin filling the inner space of the mold is cured, it is released from the mold to obtain a substrate of the reinforced resin member. Next, as shown in FIG. 2(C), by performing processing such as scraping (or cutting) a predetermined thickness from the deepest part side of the mold of the substrate of the reinforced resin member, a reinforced resin member is obtained in which the reinforcing fibers exposed on the surface that will become the sliding surface are mainly oriented along the direction perpendicular to the surface that will become the sliding surface. This method is the same whether the reinforced resin member is the stator 4 or the rotor 6.

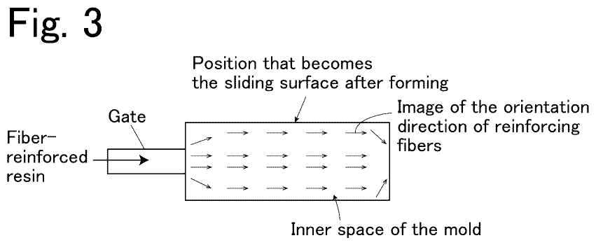

When a cylindrical reinforced resin member is formed by general injection molding, as shown in FIG. 3, the fiber-reinforced resin is often poured from the side (a direction perpendicular to the surface that will become the sliding surface after formation) into a substantially cylindrical space that is the shape of the substrate formed inside the mold. In this case, at the position that will become the sliding surface, the reinforcing fibers will be mainly oriented along the sliding surface.

Here, “the reinforcing fibers exposed on the sliding surface are mainly oriented along a direction perpendicular to the sliding surface” means that a large portion (e.g., 50% or more) of the reinforcing fibers exposed on the sliding surface of the fiber-reinforced resin is oriented in a direction that intersects (not necessarily orthogonal to) the sliding surface.

Although FIG. 2 shows an example of injection molding, the method of the present invention is not limited to this. The reinforced resin member can also be formed by a method such as extrusion molding that includes a step of causing a liquid fiber-reinforced resin to flow in a direction perpendicular to the surface that will become the sliding surface. When the reinforced resin member is formed by the injection molding of FIG. 2, a gate mark may remain on the sliding surface or on a surface parallel to the sliding surface of the reinforced resin member.

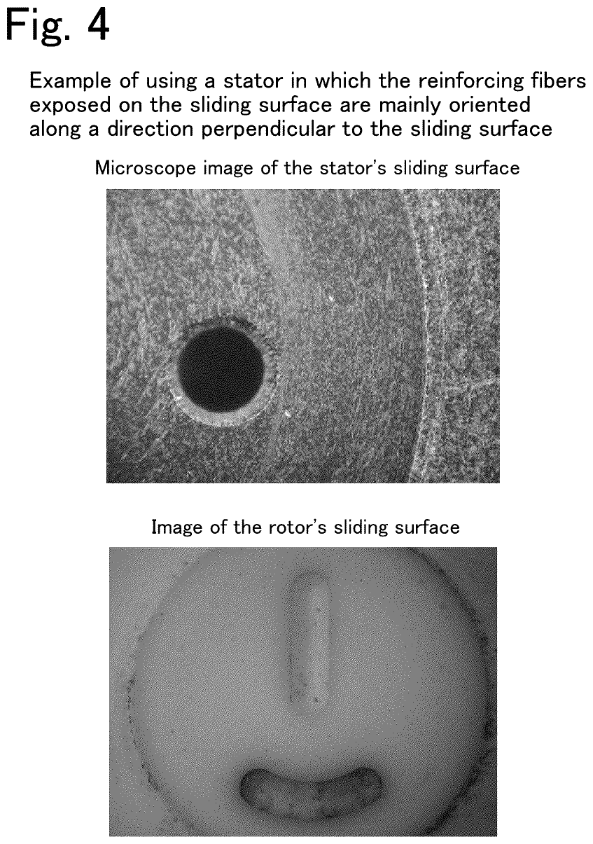

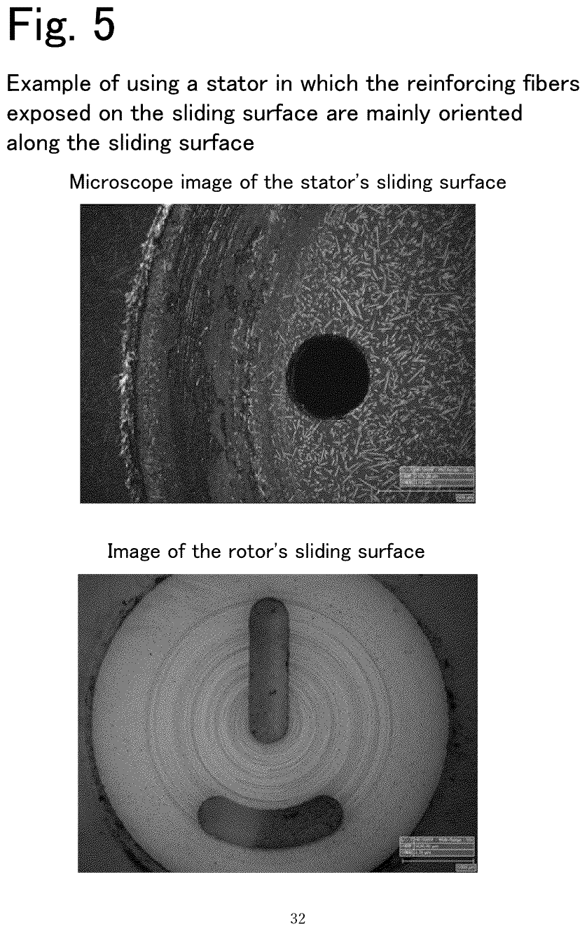

FIG. 4 is an image of the respective sliding surfaces of a stator and a rotor when a ceramic rotor was reciprocated 700,000 times against a stator in which reinforcing fibers exposed on the sliding surface were mainly oriented along a direction perpendicular to the sliding surface, and FIG. 5 is an image of the respective sliding surfaces of a stator and a rotor when a ceramic rotor was reciprocated 700,000 times against a stator in which reinforcing fibers exposed on the sliding surface were mainly oriented along the sliding surface.

Comparing the micrograph of the sliding surface of the stator shown in FIG. 4 and the micrograph of the sliding surface of the stator shown in FIG. 5, on the sliding surface of the stator in FIG. 4, the proportion of reinforcing fibers exposed as dots is high, whereas on the sliding surface of the stator in FIG. 5, the proportion of reinforcing fibers exposed as lines is high. Due to this difference, the ratio of the area where the reinforcing fibers are exposed on the sliding surface of the stator in FIG. 4 is smaller than the ratio of the area where the reinforcing fibers are exposed on the sliding surface of the stator in FIG. 5, and it is considered that the damage that the reinforcing fibers impart to the rotor is smaller for the stator of FIG. 4 than for the stator of FIG. 5.

In fact, comparing the sliding surface of the rotor shown in FIG. 4 and the sliding surface of the rotor shown in FIG. 5, it can be seen that the rotor that slid against the stator of FIG. 5 has clearly progressed in wear compared to the rotor that slid against the stator of FIG. 4. Conversely, it can be understood that by using a reinforced resin member in which the reinforcing fibers exposed on the sliding surface are mainly oriented along a direction perpendicular to the sliding surface, the wear of the member that slides against the reinforced resin member (the rotor in this example) is suppressed compared to the case where a reinforced resin member in which the reinforcing fibers exposed on the sliding surface are mainly oriented along the sliding surface is used.

Returning to FIG. 1 for further explanation, a through-hole is provided in the rotor 6, a hole is provided in the tip surface of the rotor shaft 8, and a pin 14 passing through the through-hole of the rotor 6 is fitted into the hole in the tip surface of the rotor shaft 8, whereby the rotor 6 is fixed to the rotor shaft 8 only in the rotational direction.

As shown in FIG. 6, on the surface of the rotor 6 on the rotor shaft 8 side (lower surface in the figure), a substantially spherical portion 20 projecting toward the rotor shaft 8 side is provided. The rotor 6 is in contact with the rotor shaft 8 only at the substantially spherical portion 20, and the rotor 6 can swing on the tip surface of the rotor shaft 8 so that its sliding surface (upper surface in the figure) can be slightly inclined (e.g., by a maximum of about 0.5°) from a state perpendicular to the rotation axis of the rotor shaft 8. This allows the rotor 6 to be brought into precise surface contact with the stator 4 without uneven contact when the rotor 6 is pressed against the stator 4.

The substantially spherical portion 20 does not necessarily have to be provided on the rotor 6 and may be provided on the tip surface of the rotor shaft 8.

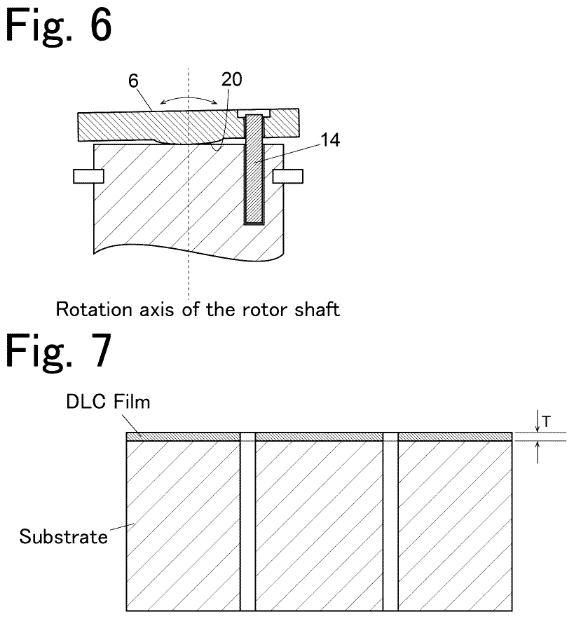

Further, one of the stator 4 and the rotor 6 may be a DLC-formed member in which the sliding surface is formed of a DLC film, as shown in FIG. 7. In that case, the thickness T from the surface of the substrate to the surface of the DLC film on the sliding surface side (upper surface side in the figure) of the DLC-formed member is 0.5 μm or less.

The inventors of the present invention conducted a durability test in which a stator composed of a stainless steel substrate with DLC films of 2 μm, 1 μm, 0.5 μm, and 0.1 μm thickness directly formed on its surface and a rotor made of fiber-reinforced resin (polyetheretherketone) were used as the stator and rotor of an autosampler injection valve (6-port, 2-position valve), and continuous switching operations were performed while feeding water as a solvent at a liquid-feeding pressure of 100 MPa. In the durability test, in the injection valve using the stator with a 2 μm thick DLC film, liquid leakage due to peeling of the DLC film occurred after about 10,000 switching operations, and in the injection valve using the stator with a 1 μm thick DLC film, liquid leakage due to peeling of the DLC film occurred after about 15,000 switching operations. On the other hand, in the injection valve using the stator with a 0.5 μm thick DLC film, no liquid leakage occurred from between the stator and the rotor even after 20,000 or more switching operations were performed, and in the injection valve using the stator with a 0.1 μm thick DLC film, no liquid leakage occurred from between the stator and the rotor even after 150,000 or more switching operations were performed. From this experimental result, it can be seen that by setting the thickness from the surface of the substrate to the surface of the DLC film of the DLC-formed member to 0.5 μm or less, the durability of the sealing performance between the stator and the rotor can be significantly improved.

In the above experiment, the DLC film is formed so as to be in direct contact with the surface of the substrate, but the present invention is not limited to this, and an adhesion layer or the like may be interposed between the surface of the substrate and the DLC film. In such a case as well, it is important that the thickness from the surface of the substrate to the surface of the DLC film is 0.5 μm or less. Even if the thickness of the DLC film is 0.5 μm or less, if the thickness from the surface of the substrate to the surface of the DLC film is greater than 0.5 μm due to the presence of an adhesion layer or the like, the step between the edge of the opening of the DLC film and the edge of the opening of the substrate in the DLC-formed member becomes large. As a result, when the DLC-formed member (the stator in the above experiment) and the soft member (the rotor in the above experiment) slide, the stress in the peeling direction that the DLC film receives from the soft member that has entered the opening of the DLC film becomes strong, and the DLC film is more likely to peel off from the substrate. Conversely, even if an adhesion layer exists between the substrate and the DLC film, by setting the thickness from the surface of the substrate to the surface of the DLC film to 0.5 μm or less, the stress in the peeling direction that the DLC film receives when the DLC-formed member and the soft member slide can be reduced, making the DLC film less likely to peel off from the substrate.

In the above experiment, the stator is the DLC-formed member and the rotor is the soft member, but the rotor may also be the DLC-formed member.

Patent Literature 2 (U.S. Pat. No. 8,438,910) discloses a DLC-formed member in which a DLC film is formed in a range of 0.2 μm to 3 μm. However, in the DLC-formed member disclosed here, an adhesion-promoting layer having a thickness in the range of 1 μm to 5 μm is interposed between the substrate and the DLC film. That is, the DLC-formed member disclosed in Patent Literature 2 has a thickness of 1.2 μm or more from the surface of the substrate to the surface of the DLC film. With such a structure, the stress in the peeling direction that the DLC film receives when the DLC-formed member and the soft member slide is large, and it is not possible to achieve the durability of the sealing performance between the stator and the rotor according to the present invention as described above.

The embodiments described above are merely examples of embodiments of the rotary valve and method according to the present invention. Embodiments of the rotary valve and method according to the present invention are as follows.

In a first embodiment of the rotary valve according to the present invention,
the rotary valve comprises: a stator; a rotor shaft that rotates on its axis; and a rotor that is held at a tip of the rotor shaft and rotates together with the rotor shaft while in surface contact with the stator,
wherein the stator and the rotor have sliding surfaces that slide against each other due to rotation of the rotor,
one of the stator and the rotor is a reinforced resin member composed of a fiber-reinforced resin containing reinforcing fibers for improving hardness, and the reinforcing fibers exposed on the sliding surface of the reinforced resin member are mainly oriented along a direction perpendicular to the sliding surface of the reinforced resin member.

In a first aspect of the first embodiment, the reinforced resin member has a gate mark from injection molding on the sliding surface or on a surface parallel to the sliding surface.

In a second aspect of the first embodiment, the reinforced resin member is the stator. By making the stator a reinforced resin member composed of a fiber-reinforced resin, the stator can be made resistant to chemicals that corrode metal. This second aspect can be combined with the first aspect.

In the second aspect, the sliding surface of the rotor may be composed of a non-metallic material harder than the stator. This can suppress the widening of rotor grooves due to wear.

In the above case, the stator may have a plurality of pipe connection parts for connecting pipes. In this way, since the stator having a plurality of pipe connection parts is composed of a fiber-reinforced resin and the rotor is composed of a non-metallic material harder than the stator, a high-pressure-resistant rotary valve can be realized while allowing the use of chemicals that corrode metal.

In a third aspect of the first embodiment, a substantially spherical portion, which is a part of either the rotor or the rotor shaft, is provided between the rotor and the rotor shaft, and the rotor and the rotor shaft are in direct contact at the substantially spherical portion, whereby the sliding surface of the rotor is capable of tilting from a state perpendicular to the rotation axis of the rotor shaft. This allows the sliding surface of the rotor to become parallel to the sliding surface of the stator so as to follow it when the rotor is pressed against the stator, enabling the rotor and the stator to slide without uneven contact. This third aspect can be combined with the first aspect and/or the second aspect.

In the third aspect, the substantially spherical portion may be provided as a projection on the surface of the rotor on the rotor shaft side. It is also possible to provide a substantially spherical projection on the rotor shaft, but providing such a projection on the rotor makes the rotor less likely to break.

In a fourth aspect of the first embodiment, the other of the stator and the rotor is a DLC-formed member whose sliding surface is formed of a diamond-like carbon film, and a thickness from a surface of a substrate to a surface of the diamond-like carbon film on the sliding surface side of the DLC-formed member is 0.5 μm or less. This fourth aspect can be combined with the first aspect, the second aspect, and/or the third aspect.

In the fourth aspect, the diamond-like carbon film of the DLC-formed member may be in direct contact with the substrate.

In a second embodiment of the rotary valve according to the present invention,
the rotary valve comprises: a stator; a rotor shaft that rotates on its axis; and a rotor that is held at a tip of the rotor shaft and rotates together with the rotor shaft while in surface contact with the stator,
wherein the stator is composed of a resin, and at least a sliding surface of the rotor that contacts the stator is formed of a material harder than the stator.

In a first aspect of the second embodiment, the resin constituting the stator is a fiber-reinforced resin containing reinforcing fibers for improving hardness. By constituting the stator with a fiber-reinforced resin, the hardness of the stator is dramatically improved compared to the case where the stator is composed of a resin, so the pressure resistance performance of the rotary valve is improved.

In a second aspect of the second embodiment, the stator has a plurality of pipe connection parts for connecting pipes.

In a third aspect of the second embodiment, the sliding surface of the rotor is formed of a diamond-like carbon film, and a thickness from a surface of a substrate to a surface of the diamond-like carbon film on the sliding surface side of the rotor is 0.5 μm or less. This third aspect can be combined with the first aspect and/or the second aspect.

In the third aspect, the diamond-like carbon film of the rotor may be in direct contact with the substrate.

In a third embodiment of the rotary valve according to the present invention,
the rotary valve comprises: a stator; a rotor shaft that rotates on its axis; and a rotor that is held at a tip of the rotor shaft and rotates together with the rotor shaft while in surface contact with the stator,
wherein a substantially spherical portion, which is a part of either the rotor or the rotor shaft, is provided between the rotor and the rotor shaft, and the rotor and the rotor shaft are in direct contact at the substantially spherical portion,
whereby the sliding surface of the rotor is capable of tilting from a state perpendicular to the rotation axis of the rotor shaft.

In the third embodiment, the substantially spherical portion may be provided as a projection on the surface of the rotor on the rotor shaft side. It is also possible to provide a substantially spherical projection on the rotor shaft, but providing such a projection on the rotor makes the rotor less likely to break.

In a fourth embodiment of the rotary valve according to the present invention,
the rotary valve comprises: a stator; and a rotor that rotates while in surface contact with the stator,
wherein each of the stator and the rotor has a sliding surface that slides against the other due to rotation of the rotor,
one of the stator and the rotor is a DLC-formed member whose sliding surface is formed of a diamond-like carbon film, and
a thickness from a surface of a substrate to a surface of the diamond-like carbon film on the sliding surface side of the DLC-formed member is 0.5 μm or less.

In the fourth embodiment, the diamond-like carbon film of the DLC-formed member may be in direct contact with the substrate. This second aspect can be combined with the first aspect.

An embodiment of a method according to the present invention is a method for forming, as a reinforced resin member composed of a fiber-reinforced resin containing reinforcing fibers for improving hardness, one of a rotor and a stator having sliding surfaces that directly contact and slide against each other in a rotary valve, the method comprising:
a flowing step of causing a liquid fiber-reinforced resin to flow in one direction that is a direction perpendicular to a surface that will become the sliding surface when formed as the reinforced resin member;
a curing step of curing the fiber-reinforced resin after the flowing step; and
a forming step of forming, after the curing step, the reinforced resin member in which the reinforcing fibers exposed on the sliding surface are mainly oriented along the direction perpendicular to the sliding surface, using the cured fiber-reinforced resin as a substrate.

### DESCRIPTION OF THE REFERENCE NUMERALS

1 Rotary valve
2 Housing
4 Stator
6 Rotor
8 Rotor shaft
10 Bearing
12 Elastic member
14 Pin
16 Retaining ring
18 Pipe connection part
20 Substantially spherical portion

1. A rotary valve, comprising:
a stator;
a rotor shaft that rotates on its axis; and
a rotor that is held at a tip of the rotor shaft and rotates together with the rotor shaft while in surface contact with the stator,
wherein the stator and the rotor have sliding surfaces that slide against each other due to rotation of the rotor,
one of the stator and the rotor is a reinforced resin member composed of a fiber-reinforced resin containing reinforcing fibers for improving hardness, and
the reinforcing fibers exposed on the sliding surface of the reinforced resin member are mainly oriented along a direction perpendicular to the sliding surface of the reinforced resin member.

2. The rotary valve according to claim 1, wherein the reinforced resin member has a gate mark from injection molding on the sliding surface or on a surface parallel to the sliding surface.

3. The rotary valve according to claim 1, wherein the reinforced resin member is the stator.

4. The rotary valve according to claim 3, wherein the sliding surface of the rotor is composed of a non-metallic material harder than the stator.

5. The rotary valve according to claim 4, wherein the stator has a plurality of pipe connection parts for connecting pipes.

6. The rotary valve according to claim 1, wherein a substantially spherical portion, which is a part of either the rotor or the rotor shaft, is provided between the rotor and the rotor shaft, and the rotor and the rotor shaft are in direct contact at the substantially spherical portion, whereby the sliding surface of the rotor is capable of tilting from a state perpendicular to a rotation axis of the rotor shaft.

7. The rotary valve according to claim 6, wherein the substantially spherical portion is provided as a projection on a surface of the rotor on the rotor shaft side.

8. The rotary valve according to claim 1, wherein the other of the stator and the rotor is a DLC-formed member whose sliding surface is formed of a diamond-like carbon film, and
a thickness from a surface of a substrate to a surface of the diamond-like carbon film on the sliding surface side of the DLC-formed member is 0.5 μm or less.

9. The rotary valve according to claim 8, wherein the diamond-like carbon film of the DLC-formed member is in direct contact with the substrate.

10. A rotary valve, comprising:
a stator;
a rotor shaft that rotates on its axis; and
a rotor that is held at a tip of the rotor shaft and rotates together with the rotor shaft while in surface contact with the stator,
wherein the stator is composed of a resin, and at least a sliding surface of the rotor that contacts the stator is formed of a material harder than the stator.

11. The rotary valve according to claim 10, wherein the resin constituting the stator is a fiber-reinforced resin containing reinforcing fibers for improving hardness.

12. The rotary valve according to claim 10, wherein the stator has a plurality of pipe connection parts for connecting pipes.

13. The rotary valve according to claim 10, wherein the sliding surface of the rotor is formed of a diamond-like carbon film, and
a thickness from a surface of a substrate to a surface of the diamond-like carbon film on the sliding surface side of the rotor is 0.5 μm or less.

14. The rotary valve according to claim 13, wherein the diamond-like carbon film of the rotor is in direct contact with the substrate.

15. A rotary valve, comprising:
a stator;
a rotor shaft that rotates on its axis; and
a rotor that is held at a tip of the rotor shaft and rotates together with the rotor shaft while in surface contact with the stator,
wherein a substantially spherical portion, which is a part of either the rotor or the rotor shaft, is provided between the rotor and the rotor shaft, and the rotor and the rotor shaft are in direct contact at the substantially spherical portion, whereby the sliding surface of the rotor is capable of tilting from a state perpendicular to a rotation axis of the rotor shaft.

16. The rotary valve according to claim 15, wherein the substantially spherical portion is provided as a projection on a surface of the rotor on the rotor shaft side.
